(19) United States
(12) Patent Application Publication
(10) Pub. No.: US 2006/0269791 A1
(43) Pub. Date: Nov. 30, 2006

(54) Magnetic recording medium, magnetic recording and reproducing apparatus, stamper, method of manufacturing stamper, and method of manufacturing magnetic recording medium

(75) Inventors: Shuichi Okawa, Tokyo (JP); Katsuyuki Nakada, Tokyo (JP); Kazuhiro Hattori, Tokyo (JP); Mitsuru Takai, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/442,258

(22) Filed: May 30, 2006

(30) Foreign Application Priority Data
May 31, 2005 (JP) 2005-159903

(51) Int. Cl. G11B 5/86; B05D 5/12; G11B 5/64

(52) U.S. Cl. 428/826; 427/129; 360/16

(57) ABSTRACT

A magnetic recording medium which has a recording layer of concavo-convex pattern and has high production efficiency, a magnetic recording and reproducing apparatus which has the magnetic recording medium, a stamper for manufacturing the magnetic recording medium, a method of manufacturing the stamper, and a method of manufacturing the magnetic recording medium are provided. Part of servo areas of the recording layer are formed in an irregular servo concavo-convex pattern in which at least some of either concave portions or convex portions are divided in a radial direction as compared with those of a basic servo concavo-convex pattern, the basic servo concavo-convex pattern having concave portions consisting of concave unit areas corresponding to cell areas for recording either an information on 0 or an information on 1, and convex portions consisting of convex unit areas corresponding to the other cell areas for recording the other information.

### BACKGROUND OF THE INVENTION

1. Field of the Invention

The invention relates to a magnetic recording medium having a recording layer whose servo areas are formed in a concavo-convex pattern, a magnetic recording and reproducing apparatus having the magnetic recording medium, a stamper for manufacturing the magnetic recording medium, a method of manufacturing the stamper, and a method of manufacturing the magnetic recording medium.

2. Description of the Related Art

Magnetic recording medium is partitioned into a plurality of data areas and a plurality of servo areas each, and servo information intended for head positioning and the like is recorded on the servo areas in use. Each servo area is partitioned into a plurality of cell areas. The servo information is recorded on a recording layer in a binary fashion so that either an information on 0 or an information on 1 is recorded on each of the cell areas according to a predetermined rule. Specifically, the servo information is composed of a preamble section, a SAM (Servo Address Mark) section, a track address signal section, a sector address signal section, a burst signal section or the like. The preamble section is intended for clock synchronization. The SAM section indicates the beginning of servo data. The track address signal section indicates a track number, and the sector address signal section a sector number. The burst signal section is intended for magnetic head tracking. Such servo information is typically recorded on the magnetic recording medium by a servo track writing method. In the process of recording the servo information, the individual cell areas inside the servo areas are magnetized one by one, from one magnetic recording medium to another. There has thus been a problem of low productivity. In particular, with the improvement of areal density and accompanying decreases in head flying height, high-density high-precision recording has also been required of servo information recently. Then, the needs for improved recording efficiency of the servo information have been growing.

In view of this, it has been proposed to form the servo areas of the recording layer in a servo concavo-convex pattern. This servo concavo-convex pattern has concave portions consisting of concave unit areas corresponding to the cell areas for recording either the information on 0 or the information on 1, and convex portions consisting of convex unit areas corresponding to the other cell areas for recording the other information (for example, see Japanese Patent Laid-Open Publications Nos. Hei 6-195907 and 9-259426). This magnetic recording medium, in which the servo areas of the recording layer are formed in such a servo concavo-convex pattern, can be magnetized exactly to the pattern of the servo information when a uniform direct-current magnetic field is applied thereto. This allows a great improvement in the recording efficiency of the servo information.

A magnetic recording medium such as hard disk has made significant growths in areal density through such refinements as reducing finer magnetic particles for forming the recording layer, changed materials, and finer head processing. Further improvement of the areal density is also hoped in the future. Nevertheless, the improvement of the areal density with these conventional refinement techniques is reaching its limit since problems are becoming evident, such as the processing limits of the magnetic heads, erroneous recording of information on other tracks adjoining to intended ones due to spreading of recording fields from the magnetic heads, and crosstalk during reproduction. As a candidate for a magnetic recording medium that can achieve a further improvement in areal density, there have been proposed discrete track medium and patterned medium. In these media, the data areas of the recording layer are formed in a concavo-convex pattern so that recording elements are formed as convex portions of the concavo-convex pattern. Manufacturing these discrete track medium or patterned medium involves the step of processing the data areas of the recording layers into the concavo-convex pattern. This step is particularly advantageous in terms of production efficiency since the servo areas of the recording layer can also be processed into a concavo-convex pattern at the same time.

As the techniques for processing a recording layer into a concavo-convex pattern, processing technique used in the field of manufacturing semiconductor products and the like can be used. In this technique, the layer to be processed is covered with a resin layer of resist material, and this resin layer is processed into a concavo-convex pattern by using an exposure- and development-based method called lithography. With this resin layer of concavo-convex pattern serving as a mask, the layer to be processed is etched into the concavo-convex pattern. The concavo-convex patterns mentioned above are fine concavo-convex patterns which include concave portions or convex portions of no greater than several hundreds of nanometers in width. When processing a resin layer into such a fine concavo-convex pattern, it is preferable to use electron beams for exposure since the wavelength of the exposure light has a non-negligible effect.

The technique of using electron beams to perform exposure (drawing) product by product, however, has a problem of low production efficiency.

To address this problem, there has been known a technique called imprinting, in which a stamper is put into contact with a resin layer so that the resin layer is formed into a concavo-convex pattern (for example, see Japanese Patent Laid-Open Publication No. 2003-100609). It should be appreciated that when the stamper is simply contacted to transfer the concavo-convex pattern, the resin layer remains in the bottoms of the concave portions without exposing the layer to be processed. It is possible, however, to expose the layer to be processed in the bottoms of the concave portions by etching the resin layer uniformly until it is removed from the bottoms of the concave portions. The remaining resin layer thus forms convex portions as high as the difference in level between the concave portions and convex portions created by the transfer, so that it can be used as a mask.

The use of lithography and imprint techniques for processing a recording layer into a concavo-convex pattern corresponding to servo information and track configuration has thus been desired. Incidentally, the resin layer may be formed directly on the recording layer for processing the recording layer into a concavo-convex pattern. On the other hand, there has also been proposed a technique of forming one or a plurality of mask layers between the recording layer and the resin layer depending on conditions such as the material of the recording layer and the type of the etching. Then, these mask layers can be etched in succession to process the recording layer into a concavo-convex pattern.

In fact, however, it has been difficult to process the servo areas of the recording layer into a fine servo concavo-convex pattern precisely by using the foregoing techniques.

For example, it has been difficult to process the resin layer into a fine, complicated servo concavo-convex pattern precisely by lithography. In particular, the track address signal section has a complicated pattern, and it has been difficult to process the resin layer into the concavo-convex pattern corresponding to the track address signal section precisely. As a result, the mask layer(s) and the recording layer have sometimes failed to be processed into the desired servo concavo-convex pattern.

In the meantime, the imprinting also uses a lithographic technique for manufacturing the stamper. It has thus been difficult to manufacture a stamper having a transfer surface of concavo-convex pattern corresponding to the fine complicated servo concave-convex pattern with sufficient precision. Moreover, even if the stamper can be manufactured with a transfer surface of sufficiently precise concavo-convex pattern, it has not always been possible to process the resin layer exactly to the concavo-convex pattern of the stamper.

Furthermore, even if the resin layer can be processed exactly to the desired pattern, it has not always been possible to etch the layer to be processed by using the resin layer as a mask while reflecting the concavo-convex pattern of the resin layer onto the layer to be processed precisely.

That is, while the recording layer can be processed into a servo concavo-convex pattern with a significant improvement in the recording efficiency of the servo information, it is difficult to process the recording layer into the servo concavo-convex pattern with high precision. The overall production efficiency of the magnetic recording medium has therefore been difficult to improve sufficiently.

### SUMMARY OF THE INVENTION

In view of the foregoing problems, various exemplary embodiments of this invention provide a magnetic recording medium which has a recording layer formed in a concavo-convex pattern and has favorable production efficiency, a magnetic recording and reproducing apparatus which has the magnetic recording medium, a stamper for manufacturing the magnetic recording medium, a method of manufacturing the stamper, and a method of manufacturing the magnetic recording medium.

To achieve the foregoing object, various exemplary embodiments of the present invention provide a magnetic recording medium comprising a recording layer, at least part of servo areas of the recording layer being formed in an irregular servo concavo-convex pattern in which at least some of either concave portions or convex portions being divided in a radial direction as compared with those of a basic servo concavo-convex pattern, the basic servo concavo-convex pattern having concave portions consisting of concave unit areas corresponding to cell areas for recording either an information on 0 or an information on 1, and convex portions consisting of convex unit areas for recording the other information.

To achieve the foregoing object, various exemplary embodiments of the present invention also provides a magnetic recording medium comprising a recording layer, at least part of servo areas of the recording layer being formed in an irregular servo concavo-convex pattern in which at least some of corners of borders between concave portions and convex portions are more acute as compared with those of the basic servo concavo-convex pattern corresponding to the corners.

In the process of conceiving the present invention, the inventors have made an intensive study of the reason why it is difficult to form a fine complicated concavo-convex pattern with high precision, and have found that the processing precision may probably be deteriorated by the following several factors.

When processing the resin layer into a fine complicated concavo-convex pattern by lithography, it is important to adjust the exposure dose to an appropriate value. If the dose is adjusted to a value that is appropriate to only some of the concave portions or convex portions having a wide variety in widths included in the complicated concavo-convex pattern then the dose may be too high or too low to the other portions. This can sometimes preclude the resin layer from being processed into the desired concavo-convex pattern precisely.

Moreover, when processing the resin layer into a concavo-convex pattern by imprinting, the imprinted resin remains in the bottoms of the concave portions with various thicknesses depending on the widths of the concave portions if the concavo-convex pattern includes concave portions of various widths. The resin tends to remain thicker in the bottoms of concave portions having excessive widths than in the other concave portions. The reasons are generally inferred as follows:

When the stamper is put into contact with the resin layer, the convex portions of the stamper squeeze the resin to flow into the concave portions of the same. If the resin layer has excessively wide concave portions and the corresponding convex portions of the stamper are excessively wide, the resin squeezed by the wide convex portions cannot flow easily. As a result, the resin remains thicker in the bottoms of the concave portions that have excessively large widths among the concave and convex portions of the resin layer. Moreover, if the resin layer has excessively wide concave portions and the corresponding convex portions of the stamper are excessively wide, the pressure acting on the areas for the convex portions of the stamper to make contact becomes lower. This can also preclude sufficient plastic deformation of the resin. Consequently, it is sometimes impossible to form a desired difference in level across the entire area of the resin layer.

When etching the imprinted resin layer uniformly to remove the resin layer from the bottoms of the concave portions, the resin can also be removed from the sides of the concave portions with slight increases in the widths of the concave portions. If the resin remaining in the bottoms of the concave portions has various thicknesses, the concave portions can vary in the degree of increase in width so that some of the concave portions become excessively large in width. To be more specific, in concave portions where the resin is completely removed from the bottoms, the side resin tends to be removed at higher speed. While the thick resin layer in the bottoms of the excessively wide concave portions is removed relatively later, the resin layer in the bottoms of the other concave portions is removed relatively earlier. This can increase the speed of removal of the side resin, with excessive increases in width. This can sometimes preclude the resin layer from being processed into a desired concavo-convex pattern precisely.

In the step of etching the layer to be processed by using the resin layer as a mask, the resin layer is also removed in part. As shown in FIG. 17, corners 100A of the convex portions of the resin layer that are convex from adjoining concave portions (in plan view taken in a direction perpendicular to the surface) are easier to be removed. In contrast, the portions corresponding to corners 100B of the concave portions that are convex from adjoining convex portions are harder to be removed. Then, both the portions are easily processed into rounded shapes. Consequently, the convex portions of the layer to be processed below also tend to be formed into rounded shapes, and the layer to be processed sometimes fails to be processed into the desired concavo-convex pattern. It should be appreciated that the hatched areas in FIG. 17 represent convex portions, and the other areas are concave portions.

In this regard, the inventors have made intensive studies further and found the following. That is, the magnetic recording medium in which the servo areas of the recording layer are formed in an irregular servo concavo-convex pattern in which at least some of either the concave portions or the convex portions are divided in the radial direction as compared with those of the basic servo concavo-convex pattern can favorably reproduce the servo information as with a magnetic recording medium in which the servo areas of the recording layer are formed in the basic servo concavo-convex pattern. The reason for this seems to be that the magnetic head flies primarily in the circumferential direction of the magnetic recording medium. That is, the division of the concave portions or convex portions in the radial direction has little effect on the reproduction of the servo information.

In this irregular servo concavo-convex pattern in which at least some of either the concave portions or the convex portions are divided in the radial direction as compared with those of the basic concavo-convex pattern, the concave portions or convex portions have a smaller range of widths as compared with those of the basic servo concavo-convex pattern. This makes it possible to adjust the exposure dose of the lithography close to an appropriate value across the entire area, and process the resin layer into a concavo-convex pattern corresponding to the irregular servo concavo-convex pattern with high precision. The layer to be processed under the resin layer can also be processed into the concavo-convex pattern corresponding to the irregular servo concavo-convex pattern with high precision. Consequently, it is easily possible to process the recording layer into the irregular servo concavo-convex pattern with high precision. In other words, the processing conditions have high tolerance, with accordingly high production efficiency.

Even when the resin layer is worked into the concavo-convex pattern by imprinting, the widths of the concave portions are suppressed in small. Therefore the resin remaining in the bottoms of the concave portions is made uniform and thin across the entire area. This can preclude or sufficiently suppress the concave portions from increasing in width when etching the imprinted resin layer uniformly until the resin layer is removed from the bottoms of the concave portions. As a result, the layer to be processed under the resin layer can also be processed into the concavo-convex pattern corresponding to the desired irregular servo concavo-convex pattern easily with high precision. Consequently, even in this case, it is easily possible to process the recording layer into the irregular servo concavo-convex pattern precisely with high production efficiency.

The inventors have also found the following. The magnetic recording medium in which at least part of the servo areas of the recording layer are formed in such an irregular servo concavo-convex pattern in which at least some of the corners of the borders between the concave portions and the convex portions are more acute as compared with those of the basic servo concavo-convex pattern corresponding to the corners can favorably reproduce servo information as with a magnetic recording medium in which the servo areas of the recording layer are formed in the basic servo concavo-convex pattern. If the corners were round, the borders between the concave portions and convex portions, defined by the corners, would show considerable differences in shape to the corresponding borders between the concave portions and convex portions of the basic servo concavo-convex pattern. On the other hand, in case the concave portions or convex portions have acute corners, these corners show smaller differences in shaper to the corresponding corners of the basic servo concavo-convex pattern. This seems to contribute the favorable reproduction of the servo information.

As above, in this irregular servo concavo-convex pattern, at least some of the corners are more acute as compared with those of the basic servo concavo-convex pattern corresponding to the corners. When processing the resin layer into a concavo-convex pattern corresponding to this irregular servo concavo-convex pattern and when etching the layer to be processed by using this resin layer as a mask, the corners of the resin layer tend to be processed closer to the shapes of the corresponding corners of the basic servo concavo-convex pattern, being less likely to be rounded, even if the resin layer is removed in part. In other words, the processing conditions have high tolerance, with accordingly high production efficiency.

Accordingly, various exemplary embodiments of the invention provide a magnetic recording medium comprising a recording layer, being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, at least part of the servo areas of the recording layer being formed in an irregular servo concavo-convex pattern in which at least some of either concave portions or convex portions are divided in a radial direction as compared with those of a basic servo concavo-convex pattern, the basic servo concavo-convex pattern having concave portions consisting of concave unit areas corresponding to the cell areas for recording either the information on 0 or the information on 1, and convex portions consisting of convex unit areas corresponding to the other cell areas for recording the other information.

Moreover, various exemplary embodiments of the invention provide a magnetic recording medium comprising a recording layer, being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, at least part of the servo areas of the recording layer being formed in an irregular servo concavo-convex pattern in which at least some of corners of borders between concave portions and convex portions are more acute as compared with those of a basic servo concavo-convex pattern corresponding to the corners, the basic servo concavo-convex pattern having concave portions consisting of concave unit areas corresponding to the cell areas for recording either the information on 0 or the information on 1, and convex portions consisting of convex unit areas corresponding to the other cell areas for recording the other information.

Furthermore, various exemplary embodiments of the invention provide a magnetic recording medium comprising a recording layer, being partitioned into a plurality of data areas and a plurality of servo areas for use, part of the servo areas of the recording layer being formed in a servo concavo-convex pattern, and wherein at least some of corners of borders between concave portions and convex portions of the servo concavo-convex pattern include protrusions which have acute interior angles and protrude to sides where the corners of the borders are convex to.

Various exemplary embodiments of the invention provide a magnetic recording and reproducing apparatus comprising: the magnetic recording medium described above; and a magnetic head for recording and reproducing data in proximity to a surface of the magnetic recording medium.

Moreover, various exemplary embodiments of the invention provide a stamper having a transfer surface of concavo-convex pattern corresponding to the concavo-convex pattern of the recording layer of the magnetic recording medium described above.

Various exemplary embodiments of the invention provide a method of manufacturing a stamper for manufacturing a magnetic recording medium having a recording layer, the magnetic recording medium being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, the servo areas of the recording layer being formed in a concavo-convex pattern of predetermined servo information, the method comprising: an exposure step of exposing portions of a resin layer of resist material formed over a resin layer supporting member, the portions corresponding to at least part of the servo areas, in an irregular servo exposure pattern for not exposing part of exposure areas of a basic servo exposure pattern so that at least some of the exposure areas of the basic servo exposure pattern are exposed as divided in a radial direction, the basic servo exposure pattern having the exposure areas consisting of exposure unit areas corresponding to the cell areas for recording either the information on 0 or the information on 1, and non-exposure areas consisting of non-exposure unit areas corresponding to the other cell areas for recording the other information; and a development step of developing the resin layer to remove either exposed portions or unexposed portions of the resin layer selectively, thereby processing the resin layer into a concavo-convex pattern corresponding to the irregular servo exposure pattern.

Various exemplary embodiments of the invention provide a method of manufacturing a magnetic recording medium having a recording layer, the magnetic recording medium being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, the method comprising: an exposure step of exposing portions of a resin layer of resist material of a workpiece, the portions corresponding to at least part of the servo areas, in an irregular servo exposure pattern for not exposing part of exposure areas of a basic servo exposure pattern so that at least some of the exposure areas of the basic servo exposure pattern are exposed as divided in a radial direction, the workpiece including a continuous recording layer yet over which the resin layer directly or indirectly formed thereon, the basic servo exposure pattern having the exposure areas consisting of exposure unit areas corresponding to the cell areas for recording either the information on 0 or the information on 1, and non-exposure areas consisting of non-exposure unit areas corresponding to the other cell areas for recording the other information; and a development step of developing the resin layer to remove either exposed portions or unexposed portions of the resin layer selectively, thereby processing the resin layer into a concavo-convex pattern corresponding to the irregular servo exposure pattern.

Alternatively, various exemplary embodiments of the invention provide a method of manufacturing a magnetic recording medium having a recording layer, the magnetic recording medium being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, the method comprising an imprinting step of bringing a stamper into contact with a resin layer of a workpiece so that portions of the resin layer corresponding to at least part of the servo areas are formed into an irregular servo concavo-convex pattern, at least some of either concave portions or convex portions of the irregular servo concavo-convex pattern being divided in a radial direction as compared with those of a basic servo concavo-convex pattern, the workpiece including a continuous recording layer yet over which the resin layer directly or indirectly formed thereon, the basic servo concavo-convex pattern having concave portions consisting of concave unit areas corresponding to the cell areas for recording either the information on 0 or the information on 1, and convex portions consisting of convex unit areas corresponding to the other cell areas for recording the other information.

As employed herein, the phrase “an information on 0 or an information on 1” shall refer to two types of information that are recorded on the recording layer in a binary fashion, such as one indicated by magnetization and the other indicated by the lack of magnetization, so that they have different magnetic properties recognizable by the magnetic head in a binary fashion.

As employed herein, the expression “a recording layer formed in a concavo-convex pattern” shall refer to the cases where the recording layer is formed as separate convex portions alone, as well as where the recording layer is formed as the tops of convex portions and the bottoms of concave portions separately, and where a continuous recording layer is shaped into both concave portions and convex portions, such as a recording layer 102 shown in FIG. 18 and a recording layer 104 shown in FIG. 19.

Moreover, as employed herein, the term “magnetic recording medium” is not limited to a hard disk, a floppy (TM) disk, a magnetic tape, and the like which use magnetism alone when recording and reproducing information. The term shall also refer to a magneto-optic recording medium which uses both magnetism and light, such as an MO (Magneto Optical), and a recording medium of thermal assisted type which uses both magnetism and heat.

According to various exemplary embodiments of the present invention, it is possible to achieve a magnetic recording medium which has a recording layer formed in a concavo-convex pattern and has high production efficiency.

### BRIEF DESCRIPTION OF THE DRAWINGS

FIG. 1 is a perspective view schematically showing the general configuration of a magnetic recording and reproducing apparatus according to a first exemplary embodiment of the present invention;

FIG. 2 is a plan view schematically showing the structure of a magnetic recording medium of the magnetic recording and reproducing apparatus;

FIG. 3 is a plan view schematically showing an enlarged servo area of the magnetic recording medium;

FIG. 4 is a plan view schematically showing an enlarged track address signal section of a basic servo concavo-convex pattern in the servo area;

FIG. 5 is a plan view schematically showing a further enlarged part of FIG. 4;

FIG. 6 is a plan view schematically showing an enlarged track address signal section of an irregular servo concavo-convex pattern on the recording layer of the magnetic recording medium;

FIG. 7 is a sectional side view schematically showing the structure of the magnetic recording medium;

FIG. 8 is a flowchart for showing the outline of the steps for manufacturing the magnetic recording medium;

FIG. 9 is a sectional side view schematically showing the structure of a stamper to be used for manufacturing the magnetic recording medium, and the process of manufacturing the stamper;

FIG. 10 is a plan view schematically showing a concavo-convex pattern on the transfer surface of the stamper;

FIG. 11 is a sectional side view schematically showing the step of imprinting onto a resin layer of a workpiece by using the stamper;

FIG. 12 is a sectional side view schematically showing the workpiece after the resin layer is removed from the bottoms of the concave portions;

FIG. 13 is a sectional side view schematically showing the workpiece of which a second mask layer is processed in concavo-convex pattern;

FIG. 14 is a plan view schematically showing an enlarged track address signal section of an irregular servo concavo-convex pattern on the recording layer of the magnetic recording medium according to a second exemplary embodiment of the present invention;

FIG. 15 is a plan view schematically showing an enlarged track address signal section of an irregular servo concavo-convex pattern on the recording layer of the magnetic recording medium according to a third exemplary embodiment of the present invention;

FIG. 16 is a flowchart showing an outline of the steps of manufacturing a magnetic recording medium according to a fourth exemplary embodiment of the present invention;

FIG. 17 is a plan view for explaining corners of borders between concave portions and convex portions employed herein;

FIG. 18 is a sectional side view showing an example of the recording layer having a concavo-convex pattern according to an exemplary embodiment of the present invention; and

FIG. 19 is a sectional side view showing another example of the recording layer having a concavo-convex pattern according to an exemplary embodiment of the present invention.

### DETAILED DESCRIPTION OF THE PREFERRED EMBODIMENTS

Hereinafter, preferred exemplary embodiments of the present invention will be described in detail with reference to the drawings.

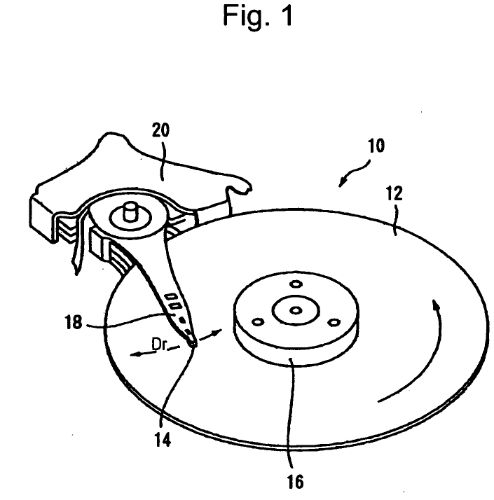

As shown in FIG. 1, a magnetic recording and reproducing apparatus 10 according to a first exemplary embodiment of the present invention comprises a magnetic recording medium 12 and a magnetic head 14. The magnetic head 14 is arranged so that it can fly in proximity to the surface of the magnetic recording medium 12 in order to record and reproduce data onto/from the magnetic recording medium 12. The magnetic recording and reproducing apparatus 10 is characterized by the configuration of the magnetic recording medium 12. Since the other configurations are not particularly indispensable to understanding the exemplary embodiment of the present invention, description thereof will be omitted when appropriate.

The magnetic recording medium 12 is fixed to a chuck 16 so that it can rotate with the chuck 16. The magnetic head 14 is mounted on near the top of an arm 18. The arm 18 is rotatably attached to a base 20. In consequence, the magnetic head 14 movably flies over the surface of the magnetic recording medium 12 so as to trace an arc along the radial direction Dr of the magnetic recording medium 12.

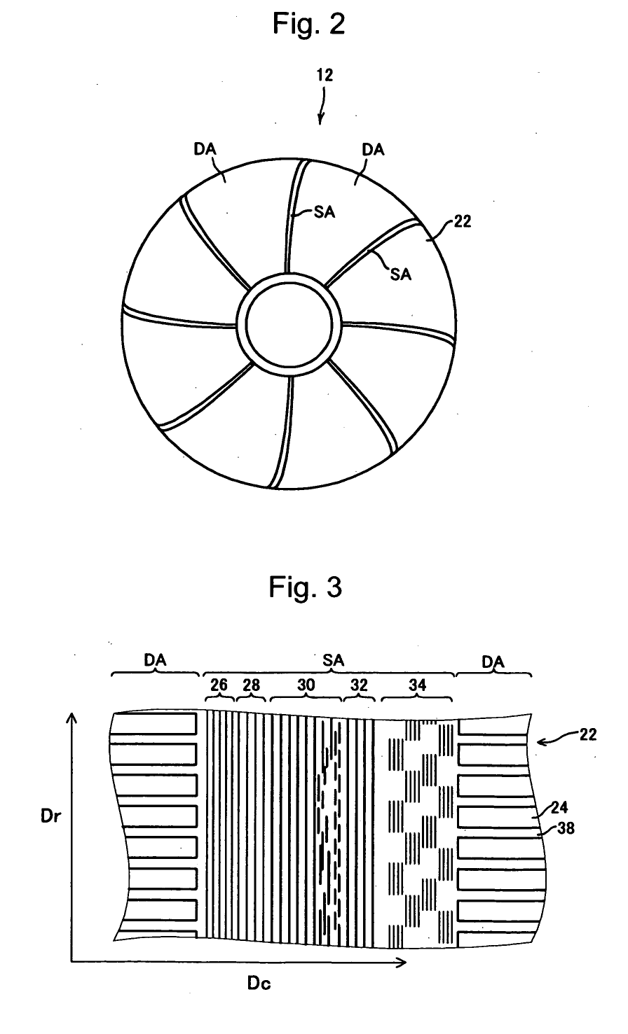

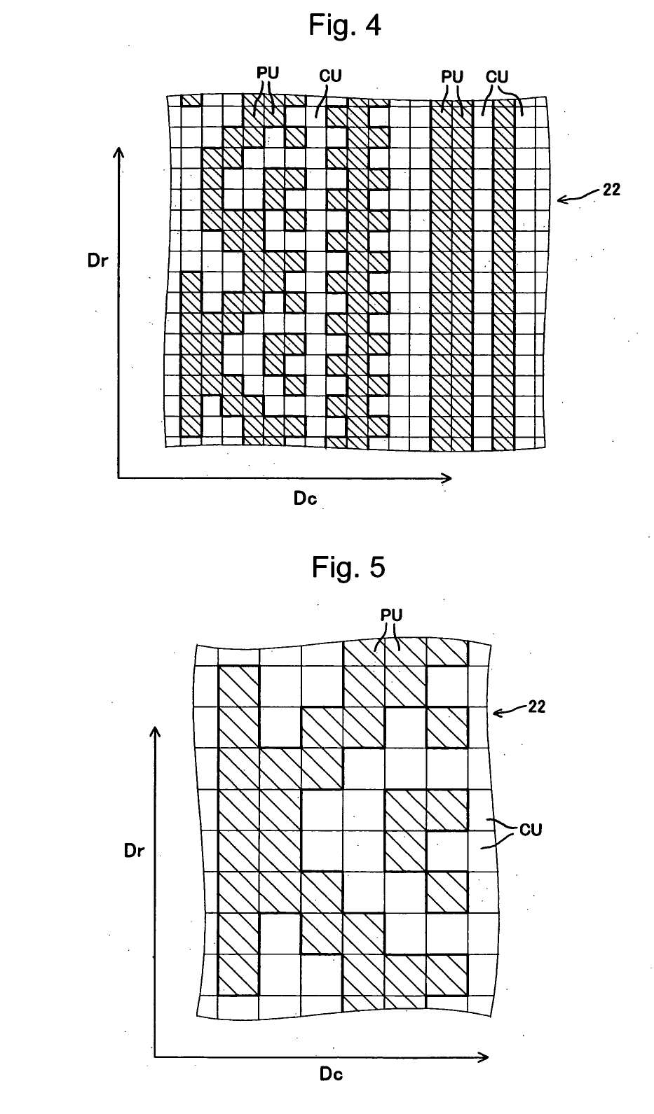

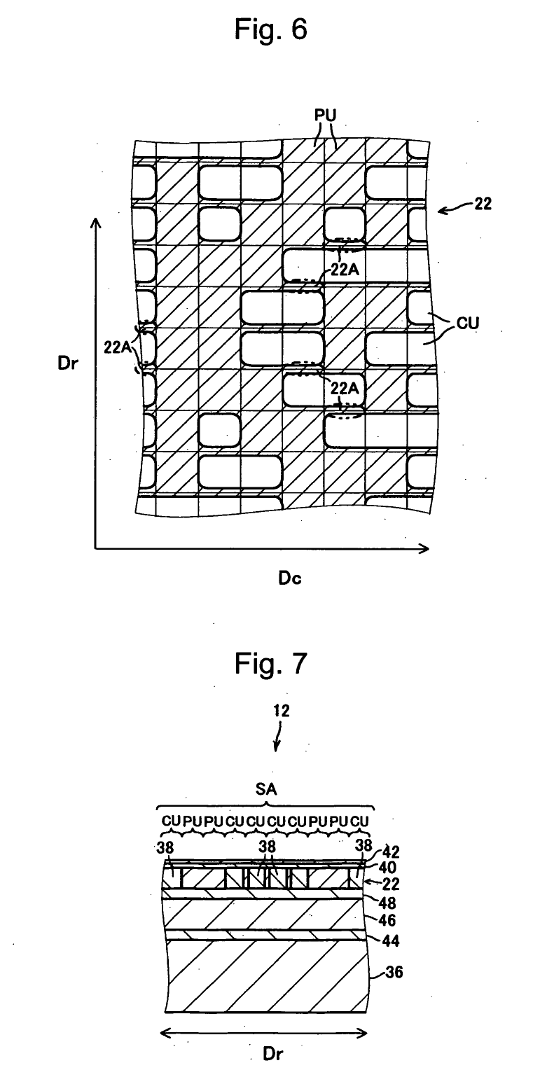

The magnetic recording medium 12 is a disk-shaped discrete track medium of perpendicular recording type, and is partitioned into a plurality of data areas DA and a plurality of servo areas SA as shown in FIGS. 2 and 3. Each of the servo areas SA is further partitioned into a plurality of cell areas. These cell areas have square like shape. Either an information on 0 or an information on 1 is recorded on each of the cell areas of its recording layer 22 in a binary fashion according to a predetermined rule for use. At least part of the servo areas of the recording layer 22 are formed in an irregular servo concavo-convex pattern as shown in FIG. 6, in which at least some of concave portions are divided in the radial direction Dr as compared with those of a basic servo concavo-convex pattern. As shown in FIGS. 4 and 5, the basic servo concavo-convex pattern has concave portions consisting of concave unit areas CU corresponding to the cell areas for recording either the information on 0 or the information 1, and convex portions consisting of convex unit areas PU corresponding to the cell areas for recording the other information. It should be appreciated that the reference symbol Dc in FIGS. 3 to 6 indicates the circumferential direction of the magnetic recording medium 12. In FIGS. 4 and 5, the cell areas shown hatched represent convex unit areas PU. The rest of the cell areas are concave unit areas CU. In FIG. 6, the hatched areas represent convex portions, and the other areas concave portions.

The irregular servo concavo-convex pattern according to the first exemplary embodiment is one in which dividing convex portions 22A are formed near the borders between some concave unit areas CU adjoining in the radial direction Dr, so that concave portions divided in the radial direction Dr are formed in the adjoining concave unit areas CU. As shown in FIG. 3, a concavo-convex pattern including this irregular servo concavo-convex pattern constitutes servo information which is composed of a preamble section 26, a SAM (Servo Address Mark) section 28, a track address signal section 30, a sector address signal section 32, and a burst signal section 34. The preamble section 26 is intended for clock synchronization. The SAM section 28 indicates the beginning of servo data. The track address signal section 30 indicates a track number, and the sector address signal section 32 indicates a sector number. The burst signal unit 34 is intended to detect the position of the magnetic head on each recording element 24 (track) of the data areas DA. FIGS. 4 to 6 show enlarged parts of the track address signal section 30. Note that FIG. 3 shows, for the sake of convenience, the convex portions of the recording layer 22 in the servo areas SA as if they have the shapes of straight lines parallel with the radial direction Dr. In fact, as shown in FIG. 6, the convex portions of the recording layer 22 also have some widths in the circumferential direction Dc.

Parts of the data areas DA of the recording layer 22 are divided into concentric arcs. As shown in FIG. 3, a large number of track-making recording elements 24 oblong in the circumferential direction Dc are formed as convex portions at a predetermined track pitch in the radial direction Dr.

This recording layer 22 has a thickness of 5 to 30 nm, and is formed over a substrate 36 as shown in FIG. 7. The recording layer 22 may be made of CoCr alloys such as a CoCrPt alloy, FePt alloys, laminates of these, and SiO₂ and other oxide materials that contain CoPt or other ferromagnetic particles as a matrix. The substrate 36 may be made of such materials as glass, NiP-coated Al alloys, Si, and Al₂O₃.

The concave portions between the recording elements 24 in the data areas DA and the concave portions between the convex portions of the recording layer 22 in the servo areas SA are filled with a filler 38. The filler 38 may be made of nonmagnetic materials including oxides such as SiO₂, Al₂O₃, TiO₂, and ferrites, nitrides such as AlN, and carbides such as SiC.

A protective layer 40 and a lubricating layer 42 are formed in this order over the recording layer 22 and the filler 38. The protective layer 40 has a thickness of 1 to 5 nm. The protective layer 40 may be made of such a material as a film of hard carbon called diamond-like carbon. The lubricating layer 42 has a thickness of 1 to 2 nm. The lubricating layer 42 may be made of a fluorine type lubricant such as PFPE (perfluoropolyether).

An antiferromagnetic layer 44, a soft magnetic layer 46, and a seed layer 48 are interposed between the substrate 36 and the recording layer 22. The seed layer 48 is intended to provide the recording layer 22 with magnetic anisotropy in the thickness direction (in a direction perpendicular to the surface). The antiferromagnetic layer 44 has a thickness of 5 to 50 nm. The antiferromagnetic layer 44 may be made of such materials as PtMn alloys and RuMn alloys. The soft magnetic layer 46 has a thickness of 50 to 300 nm. The soft magnetic layer 46 may be made of such materials as Fe (iron) alloys, Co (cobalt) amorphous alloys, and ferrites. The seed layer 48 has a thickness of 2 to 40 nm. The seed layer 48 may be made of, in concrete terms, nonmagnetic CoCr alloys, Ti, Ru, laminates of Ru and Ta, MgO, and the like.

Now, the operation of the magnetic recording and reproducing apparatus 10 will be described.

The magnetic recording and reproduction apparatus 10 has the magnetic recording medium 12 in which part of the servo areas SA of the recording layer 22 are formed in an irregular servo concavo-convex pattern in which the concave portions are divided in the radial direction Dr as compared with those of the basic servo concavo-convex pattern. The concave portions included in the irregular servo concavo-convex pattern have a smaller range of widths as compared with those in the basic servo concavo-convex pattern. As will be described later, this makes it easily possible to process the servo areas SA of the recording layer 22 into the irregular servo concavo-convex pattern with high precision.

Since the servo areas SA of the recording layer 22 are formed in the concavo-convex pattern that reflects servo information, the servo information is recorded efficiently without fail by the application of a direct-current magnetic field. To be more specific, either the information on 0 or the information on 1 is recorded by magnetizing each convex portion of the servo areas SA in a predetermined direction perpendicular to the surface. The other information is recorded by not magnetizing the concave portions.

That is, the magnetic recording and reproducing apparatus 10 has high production efficiency since its magnetic recording medium 12 is easy to manufacture and to record servo information on.

The magnetic recording and reproducing apparatus 10 has the magnetic recording medium 12 in which part of the servo areas SA of the recording layer 22 are formed in the irregular servo concavo-convex pattern in which concave portions are divided in the radial direction Dr as compared with those of the basic servo concavo-convex pattern. Despite this configuration, the magnetic head 14 can reproduce the servo information favorably as with a magnetic recording medium in which the servo areas SA of the recording layer are formed in the basic servo concavo-convex pattern. The reason for this seems to be that, since the magnetic head 14 flies primarily in the circumferential direction Dc of the magnetic recording medium 12, the division of the concave portions in the radial direction Dr has little effect on the reproduction of the servo information. In particular, the irregular servo concavo-convex pattern of the recording layer 22 is one in which the dividing convex portion 22A is formed near the border between at least two concave unit areas CU adjoining in the radial direction Dr, so that concave portions divided in the radial direction Dr are formed in the adjoining concave unit areas CU. This clarifies the correspondence between the individual concave unit areas CU and the concave portions formed therein, probably contributing to the favorable reproduction of the servo information.

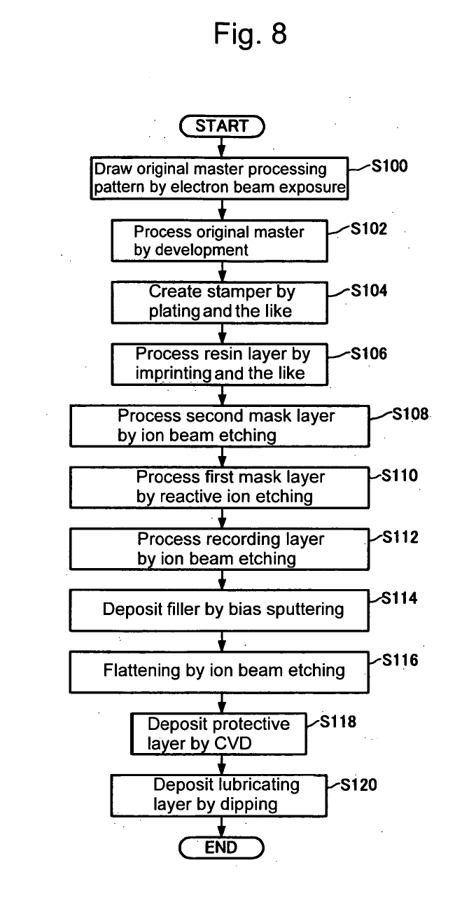

Next, a method of manufacturing the magnetic recording medium 12 will be described with reference to the flowchart shown in FIG. 8.

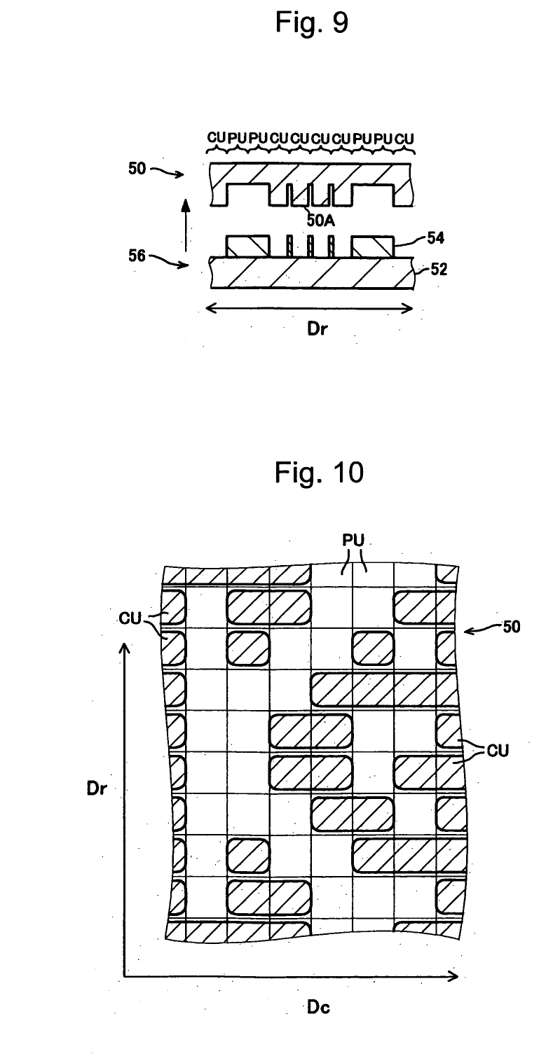

Initially, a stamper 50 such as shown in FIG. 9 is manufactured. This stamper 50 has a transfer surface 50A of concavo-convex pattern corresponding to the concavo-convex pattern of the recording layer 22 of the magnetic recording medium 12. To be more specific, a positive resist material is initially applied onto a substrate (resin layer supporting member) 52 of Si, glass, or the like, thereby forming a resin layer 54. This resin layer 54 is exposed (drawn) by using electron beams or the like, in an exposure pattern corresponding to concavo-convex pattern including same irregular servo concavo-convex pattern as that of the concavo-convex pattern of the recording layer 22 (S100).

Specifically, the resin layer 54 is exposed in an exposure pattern that includes an irregular servo exposure pattern (see FIG. 6) for not exposing part of exposure areas of a basic servo exposure pattern (see FIGS. 4 and 5) so that at least some of the exposure areas of the basic servo exposure pattern are exposed as divided in the radial direction Dr. Here, the basic servo exposure pattern has the exposure areas consisting of exposure unit areas corresponding to cell areas corresponding to the concave unit areas CU, and non-exposure areas consisting of non-exposure unit areas that correspond to cell areas corresponding to the convex unit areas PU. To be more specific, the resin layer 54 is exposed in an exposure pattern that includes an irregular exposure pattern for exposing the exposure unit areas except the vicinities of the borders between exposure unit areas adjoining in the radial direction Dr, thereby exposing the adjoining exposure unit areas as divided in the radial direction Dr. That is, the areas corresponding to the concave portions of the concavo-convex pattern of the recording layer 22 are exposed by electron beams or the like.

Next, the exposed portions of the resin layer 54 are removed by development, whereby the resin layer 54 is thus processed into a concavo-convex pattern having same concavo-convex relation as that of the concavo-convex pattern of the recording layer 22. This creates an original master 56 (S102). The irregular servo concavo-convex pattern is a concavo-convex pattern in which the concave portions are divided in the radial direction Dr as compared with those of the basic servo concavo-convex pattern, and its concave portions have a narrower range of widths as compared with those of the basic servo concavo-convex pattern. This makes it possible to adjust the exposure dose closer to an appropriate value across the entire area. Consequently, the resin layer 54 can be easily processed into a desired concavo-convex pattern including the concavo-convex pattern corresponding to this irregular servo concavo-convex pattern with high precision.

Next, a conductive film (not shown) is deposited on the resin layer 54 of the original master 56 by vapor deposition, electroless plating, or the like. An electrolytic plating layer of Ni (nickel) or the like is then formed by electrolytic plating, using the conductive film as an electrode. The conductive film and the electrolytic plating layer are released together from the original master, whereby the stamper 50 having the transfer surface 50A is created (S104). As shown in FIGS. 9 and 10, the transfer surface 50A has a concavo-convex pattern having reverse concavo-convex relation to that of the concavo-convex pattern of the recording layer 22 (a concavo-convex pattern having convex portions formed so as to correspond to the concave portions of the concavo-convex pattern of the recording layer 22 and concave portions formed so as to correspond to the convex portions of the concavo-convex pattern of the recording layer 22). In FIG. 10, the hatched areas represent convex portions, and the other areas concave portions. Note that while the concave unit areas CU and the convex unit areas PU are the areas formed in/on the recording layer 22, FIG. 10 employs the same symbols for the sake of contrast between the concavo-convex patterns of the stamper 50 and the recording layer 22. That is, for convenience, the symbol CU in FIG. 10 designates the areas of the stamper 50 corresponding to the concave unit areas CU of the recording layer 22, and the symbol PU designates the areas of the stamper 50 corresponding to the convex unit areas PU of the recording layer 22.

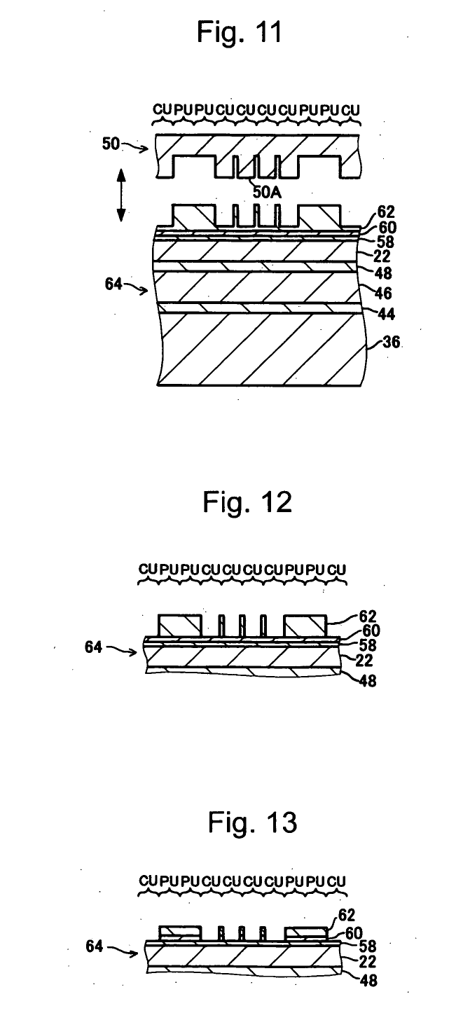

Next, a workpiece 64 such as shown in FIG. 11 is prepared. More specifically, the workpiece 64 has an antiferromagnetic layer 44, a soft magnetic layer 46, a seed layer 48, a recording layer 22 (continuous layer yet to be processed), a first mask layer 58, a second mask layer 60, and a resin layer 62 are formed over a substrate 36 in this order. Then, the concavo-convex pattern on the transfer surface 50A of the stamper 50 is transferred to the resin layer 62 by imprinting (S106). Here, the first mask layer 58 may be made of C (carbon), and the second mask layer 60 may be made of Ni, for example. The resin layer 62 may be made of a resist material or the like. As shown in FIG. 11, the resin layer 62 is formed into a concavo-convex pattern having same concavo-convex relation as that of the concavo-convex pattern of the recording layer 22. The irregular servo concavo-convex pattern is a concavo-convex pattern in which the concave portions are divided in the radial direction as compared with those of the basic servo concavo-convex pattern, and the corresponding convex portions on the transfer surface 50A of the stamper 50 have small widths. The resin layer 62 remaining in the bottoms of the concave portions thus has a uniform small thickness across the entire area.

As shown in FIG. 12, the resin layer 62 is etched uniformly by reactive ion etching, using O₂ or O₃ gas, until the portions of the resin layer 62 lying in the bottoms of the concave portions are removed. As a result, the second mask layer 60 is exposed in the bottoms of the concave portions. Since the resin layer 62 remaining in the bottoms of the concave portions has a uniform thickness across the entire areas, it is possible to remove the portions of the resin layer 62 from the bottoms of the concave portions in an almost uniform time across the entire area. This makes it possible to avoid or sufficiently suppress variations in the widths of the concave portions.

Next, the second mask layer 60 is etched by ion beam etching using Ar gas, with the resin layer 62 as a mask (S108). As shown in FIG. 13, the second mask layer 60 is processed into a concavo-convex pattern having same concavo-convex relation as that of the concavo-convex pattern of the recording layer 22 with high precision.

Next, the first mask layer 58 is removed from the bottoms of the concave portions by reactive ion etching using SF₆ gas (S110) Moreover, the recording layer 22 in the bottoms of the concave portions is removed by ion beam etching using Ar gas, thereby processing the recording layer 22 into a concavo-convex pattern (S112). The recording layer 22 is thus processed into the concavo-convex pattern including the irregular servo concavo-convex pattern of the servo areas SA as shown in FIG. 6 seen above, with a high degree of precision.

Next, the filler 38 is deposited over the recording layer 22 by bias sputtering (S114). Ion beam etching is then performed so that Ar gas is applied obliquely to the surface of the recording layer 22, thereby removing redundancy of the filler 38 to flatten the surface (S116).

Next, the protective layer 40 is deposited over the recording layer 22 and the filler 38 by CVD (S118). Moreover, the lubricating layer 42 is deposited over the protective layer 40 by dipping (S120). This completes the magnetic recording medium 12.

As described above, in this magnetic recording medium 12, the servo areas SA of the recording layer 22 are formed in the irregular servo concavo-convex pattern in which the concave portions are divided in the radial direction as compared with those of the basic servo concavo-convex pattern. Since the concave portions of the irregular servo concavo-convex pattern have a smaller range of widths as compared with those of the basic servo concavo-convex pattern, it is therefore possible to adjust the lithographic exposure dose closer to an appropriate value across the entire area. Consequently, the resin layer 54 of the original master 56 can be easily processed into the concavo-convex pattern corresponding to this irregular servo concavo-convex pattern with high precision. This makes it easily possible to create the stamper 50 with high precision.

Moreover, even when transferring the concavo-convex pattern on the transfer surface 50A of the stamper 50 to the resin layer 62 of the workpiece 64 by imprinting, the concavo-convex pattern corresponding to the irregular servo concavo-convex pattern to be transferred to the portions corresponding to the servo areas SA has concave portions that are divided in the radial direction Dr as compared with those of the basic servo concavo-convex pattern. Since the widths of the concave portions of the irregular servo concavo-convex pattern are small, the resin layer 62 remaining in the bottoms of the concave portions becomes uniformly thin across the entire area. This precludes or sufficiently suppresses the concave portions from increasing in width when etching the imprinted resin layer 62 uniformly to remove the resin layer 62 from the bottoms of the concave portions. That is, the resin layer 62 can be easily processed into a concavo-convex pattern that includes the concavo-convex pattern corresponding to the irregular servo concavo-convex pattern with high precision. Based on this resin layer 62 of concavo-convex pattern, the second mask layer 60 and the first mask layer 58 are successively processed into a concavo-convex pattern that includes concavo-convex pattern corresponding to the irregular servo concavo-convex pattern easily with high precision. In consequence, the recording layer 22 is processed into the concavo-convex pattern including the irregular servo concavo-convex pattern with high precision.

Next, description will be given of a second exemplary embodiment of the present invention.

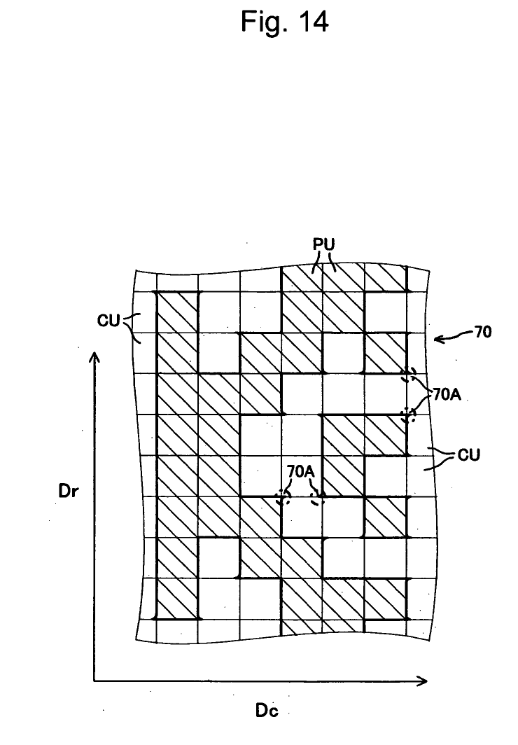

The second exemplary embodiment is characterized by that the servo areas SA of a recording layer 70 are formed in such an irregular servo concavo-convex pattern as shown in FIG. 14. More specifically, in the irregular servo concavo-convex pattern, some of corners 70A of borders between concave portions and convex portions are more acute as compared with those of the basic servo concavo-convex pattern corresponding to the corners 70A. Here, as shown in FIGS. 4 and 5, the basic servo concavo-convex pattern has concave portions consisting of concave unit areas corresponding to cell areas for recording either an information on 0 or an information on 1, and convex portions consisting of convex unit areas corresponding to cell areas for recording the other information. Since the rest of the configuration is the same as in the first exemplary embodiment, description thereof will be omitted.

When the recording layer 70 is processed into the irregular servo concavo-convex pattern such that the corners 70A of the borders between the concave portions and convex portions are more acute as compared with those of the basic servo concavo-convex pattern corresponding to the corners 70A, the corners 70A are less likely to be rounded. More specifically, when the resin layer 54 of the original master 56 is processed into a concavo-convex pattern corresponding to this irregular servo concavo-convex pattern, and when the second mask layer 60 is etched by using the resin layer 62 of the workpiece 64 as a mask, the corners 70A are processed closer to the shapes of the corresponding corners of the basic servo concavo-convex pattern even if the convex portions of the resin layers 54 and 62 are removed in part. In other words, the processing conditions have high tolerance, with accordingly high production efficiency.

The servo areas SA of the recording layer 70 are formed in the irregular servo concavo-convex pattern such that the corners 70A of the borders between the concave portions and convex portions are more acute as compared with those of the basic servo concavo-convex pattern corresponding to the corners 70A. Despite this configuration, it is possible to reproduce the servo information favorably as with a magnetic recording medium in which the servo areas SA of the recording layer are formed in the basic servo concavo-convex pattern. If the corners were round, they would show considerable differences in shape to the corresponding corners of the basic servo concavo-convex pattern. Since the corners of the borders between the concave portions and convex portions are more acute as compared with the corresponding corners of the basic concave-convex pattern, they show smaller differences in shape. This seems to contribute the favorable reproduction of the servo information. For favorable reproduction of the servo information, the irregular servo concavo-convex pattern is preferably configured so that the corners of the borders between the concave portions and convex portions include protrusions that have acute interior angles and protrude to the sides where the corners are convex to (in plan view taken in a direction perpendicular to the surface).

In the foregoing first exemplary embodiment, the basic servo concavo-convex pattern shown in FIGS. 4 and 5 is exemplified as a basic servo concavo-convex pattern of the servo areas SA of the recording layer 22, and the irregular servo concavo-convex pattern shown in FIG. 6 is exemplified as an irregular servo concavo-convex pattern of the servo areas SA of the recording layer 22. In the second exemplary embodiment, irregular servo concavo-convex pattern shown in FIG. 14 is exemplified as an irregular servo concavo-convex pattern of the servo areas SA of the recording layer 70. Nevertheless, the basic servo concavo-convex pattern and the irregular servo concavo-convex pattern of the recording layer may be determined as appropriate, depending on performance requirements and the like.

For example, FIG. 3 shows the case where the servo information is composed of the preamble section 26, the SAM section 28, the track address signal section 30, the sector address signal section 32, and the burst signal section 34. Depending on required performance and the like, however, the servo information may be partly rearranged, be partly omitted, or include other functional sections. The basic servo concavo-convex pattern and the irregular servo concavo-convex pattern of the recording layer may be determined as appropriate depending on such servo information.

The cell areas for partitioning the servo areas SA are not limited to squares or rectangles having right interior angles, but may be parallelograms.

In the first exemplary embodiment, the irregular servo concavo-convex pattern of the recording layer 22 has the convex portions near the borders between concave unit areas CU adjoining in the radial direction Dr, so that concave portions divided in the radial direction Dr are formed in the adjoining concave unit areas CU. Nevertheless, as long as the magnetic head 14 can recognize each concave unit area CU as a concave portion without fail, the irregular servo concavo-convex pattern may be configured so that the convex portions are formed in other locations of the concave unit areas CU, and the concave portions are divided in the radial direction Dr as compared with those of the basic servo concavo-convex pattern.

In the first exemplary embodiment, the irregular servo concavo-convex pattern of the recording layer 22 is one in which the concave portions are divided in the radial direction Dr as compared with those of the basic servo concavo-convex pattern. Nevertheless, the irregular servo concavo-convex pattern may be one in which the convex portions are divided in the radial direction Dr as compared with those of the basic servo concavo-convex pattern. In the first exemplary embodiment, the resin layer 54 of the original master 56 is made of a positive resist material, and the areas of the resin layer 54 corresponding to the concave portions of the recording layer 22 are exposed. When the irregular servo concavo-convex pattern is one in which the convex portions are divided in the radial direction Dr as compared with those of the basic servo concavo-convex pattern, then a negative resist material can be used to make the resin layer 54 of the original master 56. In this case, the areas of the resin layer 54 corresponding to the convex portions of the recording layer 22 are exposed. Therefore, the range of widths of the exposed portions becomes smaller than in the basic servo concavo-convex pattern by using negative resist material as material for the resin layer 54. This makes it possible to adjust the exposure dose closer to an appropriate value across the entire area. As a result, it is possible to manufacture the original master with high precision, and easily process the recording layer into the concavo-convex pattern including this irregular servo concavo-convex pattern with high precision. It should be appreciated that the resin layer 54 of the original master 56 may be made of a positive resist material as in the foregoing first exemplary embodiment. Here, a stamper 50 is manufactured from the original master 56, and then the stamper 50 is used as a metal master (original master) to manufacture another stamper that has a transfer surface of concavo-convex pattern having reverse concavo-convex relation to that of the stamper 50. By using the last stamper, it is possible to transfer a concavo-convex pattern corresponding to the irregular servo concavo-convex pattern in which the convex portions are divided in the radial direction Dr as compared with those of the basic servo concavo-convex pattern, to the resin layer 62 and process the recording layer 22 into the irregular servo concavo-convex pattern.

In FIG. 6 of the first exemplary embodiment, the recording layer 22 has the irregular servo concavo-convex pattern in which all the borders between the concave unit areas CU of the basic servo concavo-convex pattern adjoining in the radial direction Dr are provided with respective convex portions. That is, the concave portions of the concave unit areas CU are all divided in the radial direction Dr. Nevertheless, as long as the servo information can be reproduced favorably, the irregular servo concavo-convex pattern may be one in which convex portions are formed on the borders between some of concave unit areas CU of the basic servo concavo-convex pattern adjoining in the radial direction Dr. In this case, the concave portions of some of the concave unit areas CU are divided in the radial direction Dr.

In FIG. 14 of the second exemplary embodiment, the recording layer 70 has the irregular servo concavo-convex pattern in which the corners of the convex portions, convex to adjoining concave portions (in plan view taken in a direction perpendicular to the surface), out of the corners of the borders between the concave portions and convex portions, are more acute as compared with those of the basic servo concavo-convex pattern corresponding to the corners. Instead, the irregular servo concavo-convex pattern may be configured so that corners of concave portions convex to adjacent convex portions are more acute as compared with those of the basic servo concavo-convex pattern corresponding to the corners.

In FIG. 14 of the second exemplary embodiment, the recording layer 70 has the concavo-convex pattern in which the corners 70A of the convex portions, convex to adjoining concave portions, out of the corners of the borders between the concave portions and convex portions, include the protrusions that have acute interior angles and protrude to the sides where the corners are convex to. Nevertheless, the concavo-convex pattern may be configured so that the corners of concave portions, convex to adjacent convex portions include protrusions that have acute interior angles and protrude to the sides where the corners of the borders are convex. Even in this case, the servo information can be reproduced favorably.

In FIG. 14 of the second exemplary embodiment, the recording layer 70 has the irregular servo concavo-convex pattern in which all the corners of convex portions, protruding to adjacent concave portions, out of the corners of the borders between the concave portions and convex portions, are more acute as compared with those of the basic servo concavo-convex pattern corresponding to the corners. Instead, the irregular servo concavo-convex pattern may be configured so that some of the corners of the borders between the concave portions and convex portions are more acute as compared with those between the concave unit areas CU and convex unit areas PU corresponding to the corners.

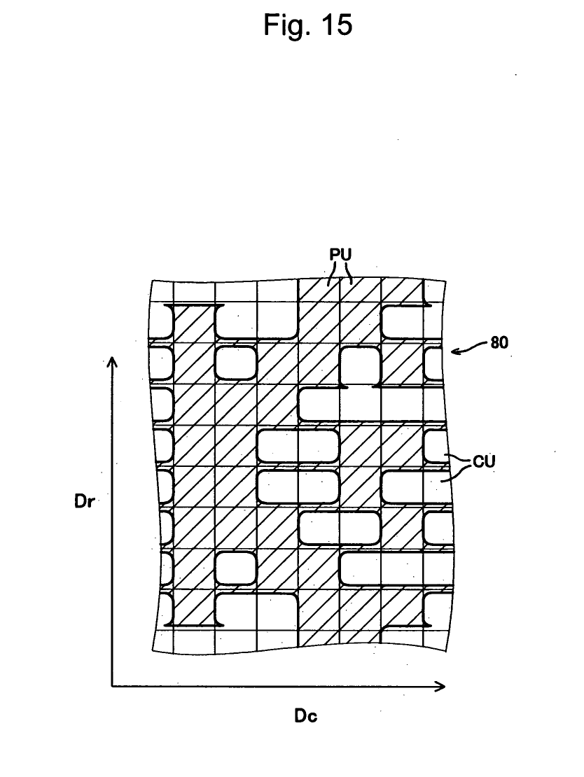

According to the first exemplary embodiment, the recording layer 22 has the irregular servo concavo-convex pattern in which the concave portions are divided in the radial direction Dr as compared with those of the basic servo concavo-convex pattern. According to the second exemplary embodiment, the recording layer 70 has the irregular servo concavo-convex pattern in which the borders between the concave portions and convex portions have corners more acute as compared with those of the basic servo concavo-convex pattern corresponding to the corners. Nevertheless, as in a recording layer 80 according to a third exemplary embodiment of the present invention shown in FIG. 15, the irregular servo concavo-convex pattern may be configured so that some of the concave portions or convex portions are divided in the radial direction Dr as compared with those of the basic servo concavo-convex pattern, and some of the corners of the borders between the concave portions and convex portions are more acute as compared with those of the basic servo concavo-convex pattern corresponding to the corners.

FIG. 6 of the first exemplary embodiment, FIG. 14 of the second exemplary embodiment, and FIG. 15 of the third exemplary embodiment show the enlarged track address signal sections 30 in the servo areas SA of the recording layers 22, 70, and 80, respectively. The areas of the recording layer to be formed in an irregular servo concavo-convex pattern may be the entire servo areas SA, or may be limited to where the concavo-convex pattern is fine and complicated, like the track address signal sections 30.

In the first exemplary embodiment, the workpiece 64 is configured so that the first mask layer 58, the second mask layer 60, and the resin layer 62 are formed over the recording layer 22. These layers are then successively etched to process the recording layer 22 into the concavo-convex pattern including the irregular servo concavo-convex pattern. The materials, thicknesses, and the number of laminations of the mask layers between the recording layer and the resin layer are not particularly limited, as long as the recording layer can be processed into the concavo-convex pattern including the irregular servo concavo-convex pattern with high precision. For example, the number of mask layers between the recording layer and the resin layer may be one, or more than two. Otherwise, the resin layer may be formed directly on the recording layer.

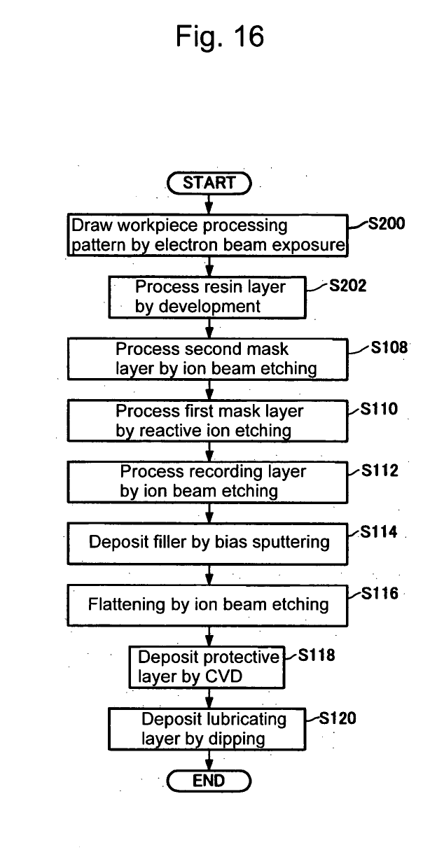

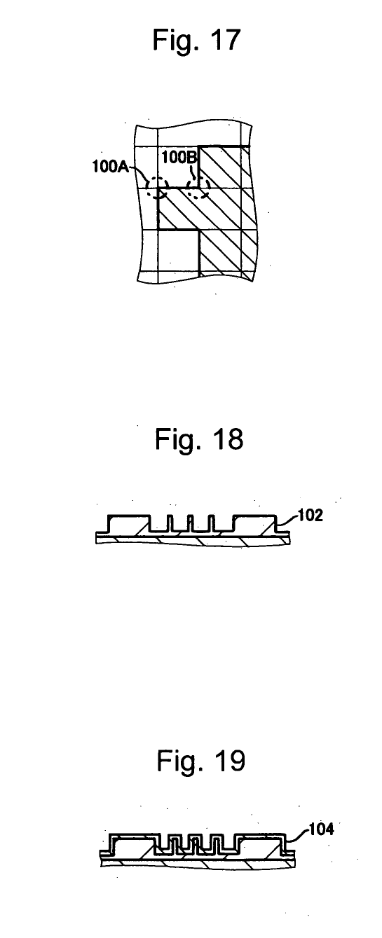

In the first exemplary embodiment, the stamper 50 is used to imprint the concavo-convex pattern onto the resin layer 62 of the workpiece 64. Nevertheless, as in a fourth exemplary embodiment of the present invention shown by the flowchart of FIG. 16, the resin layer 62 made of a resist material may be exposed (S200) and developed (S202) to form the resin layer 62 in the concavo-convex pattern. Even in this case, the servo areas SA can be formed in an irregular servo concavo-convex pattern in which at least some of the concave portions or convex portions are divided in the radial direction Dr as compared with those of the basic servo concavo-convex pattern. This makes it possible to adjust the exposure dose closer to an appropriate value across the entire area, and process the resin layer 62 into a desired concavo-convex pattern including the concavo-convex pattern corresponding to the irregular servo concavo-convex pattern with high precision.

In the first to third exemplary embodiments, the magnetic recording layer 12 includes the filler 38 which is filled into the concave portions between the convex portions of the recording layer 22, 70, or 80. Nevertheless, the concave portions between the convex portions of the recording layers 22, 70, and 80 need not be filled as long as the magnetic head 14 has a sufficient flying characteristic.

The first to third exemplary embodiments have dealt with the magnetic recording media 12 of discrete track type in which parts of the data areas DA of the recording layers 22, 70, and 80 are divided into a large number of recording elements 24 at a fine pitch in the radial direction Dr. Nevertheless, the present invention may be applied to patterned media in which parts of the data areas DA of the recording layer are divided into a large number of recording elements at fine pitches in the radial direction Dr and the circumferential direction Dc. The present invention may also be applied to magnetic recording media in which parts of the data areas DA of the recording layer are continuous of uniform thickness.

The first to third exemplary embodiment have dealt the magnetic recording media 12 of perpendicular recording type, whereas the present invention may also be applied to magnetic recording media of longitudinal recording type.

The present invention is applicable to magnetic recording media having a recording layer of concavo-convex pattern.

What is claimed is:

1. A magnetic recording medium comprising a recording layer,
being partitioned into a plurality of data areas and a plurality of servo areas,
each of the servo areas being further partitioned into a plurality of cell areas,
either an information on 0 or an information on 1 being recorded on each of the cell areas of the recording layer for use in a binary fashion according to a predetermined rule,
at least part of the servo areas of the recording layer being formed in an irregular servo concavo-convex pattern in which at least some of either concave portions or convex portions are divided in a radial direction as compared with those of a basic servo concavo-convex pattern,
the basic servo concavo-convex pattern having concave portions consisting of concave unit areas corresponding to the cell areas for recording either the information on 0 or the information on 1, and convex portions consisting of convex unit areas corresponding to the other cell areas for recording the other information.

2. The magnetic recording medium according to claim 1, wherein
the irregular servo concavo-convex pattern is one in which a convex portion is formed near a border between at least two concave unit areas adjoining in the radial direction out of the concave unit areas to form concave portions divided in the radial direction in the adjoining concave unit areas.

3. The magnetic recording medium according to claim 1, wherein
the irregular servo concavo-convex pattern is one in which a concave portion is formed near a border between at least two convex unit areas adjoining in the radial direction out of the convex unit areas to form convex portions divided in the radial direction in the adjoining convex unit areas.

4. The magnetic recording medium according to claim 1, wherein
the irregular servo concavo-convex pattern is one in which at least some of corners of borders between the concave portions and the convex portions are more acute as compared with those of the basic servo concavo-convex pattern corresponding to the corners.

5. A magnetic recording medium comprising a recording layer,
being partitioned into a plurality of data areas and a plurality of servo areas,
each of the servo areas being further partitioned into a plurality of cell areas,
either an information on 0 or an information on 1 being recorded on each of the cell areas of the recording layer for use in a binary fashion according to a predetermined rule,
at least part of the servo areas of the recording layer being formed in an irregular servo concavo-convex pattern in which at least some of corners of borders between concave portions and convex portions are more acute as compared with those of a basic servo concavo-convex pattern corresponding to the corners,
the basic servo concavo-convex pattern having concave portions consisting of concave unit areas corresponding to the cell areas for recording either the information on 0 or the information on 1, and convex portions consisting of convex unit areas corresponding to the other cell areas for recording the other information.

6. A magnetic recording medium comprising a recording layer, being partitioned into a plurality of data areas and a plurality of servo areas for use, part of the servo areas of the recording layer being formed in a servo concavo-convex pattern, and wherein
at least some of corners of borders between concave portions and convex portions of the servo concavo-convex pattern include protrusions which have acute interior angles and protrude to sides where the corners of the borders are convex to.

7. A magnetic recording and reproducing apparatus comprising:
the magnetic recording medium according to claim 1; and
a magnetic head for recording and reproducing data in proximity to a surface of the magnetic recording medium.

8. A magnetic recording and reproducing apparatus comprising:
the magnetic recording medium according to claim 2; and
a magnetic head for recording and reproducing data in proximity to a surface of the magnetic recording medium.

9. A magnetic recording and reproducing apparatus comprising:
the magnetic recording medium according to claim 5; and
a magnetic head for recording and reproducing data in proximity to a surface of the magnetic recording medium.

10. A magnetic recording and reproducing apparatus comprising:
the magnetic recording medium according to claim 6; and
a magnetic head for recording and reproducing data in proximity to a surface of the magnetic recording medium.

11. A stamper having a transfer surface of concavo-convex pattern corresponding to the concavo-convex pattern of the recording layer of the magnetic recording medium according to claim 1.

12. A stamper having a transfer surface of concavo-convex pattern corresponding to the concavo-convex pattern of the recording layer of the magnetic recording medium according to claim 2.

13. A stamper having a transfer surface of concavo-convex pattern corresponding to the concavo-convex pattern of the recording layer of the magnetic recording medium according to claim 5.

14. A stamper having a transfer surface of concavo-convex pattern corresponding to the concavo-convex pattern of the recording layer of the magnetic recording medium according to claim 6.

15. A method of manufacturing a stamper for manufacturing a magnetic recording medium having a recording layer, the magnetic recording medium being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, the servo areas of the recording layer being formed in a concavo-convex pattern of predetermined servo information, the method comprising:
an exposure step of exposing portions of a resin layer of resist material formed over a resin layer supporting member, the portions corresponding to at least part of the servo areas, in an irregular servo exposure pattern for not exposing part of exposure areas of a basic servo exposure pattern so that at least some of the exposure areas of the basic servo exposure pattern are exposed as divided in a radial direction, the basic servo exposure pattern having the exposure areas consisting of exposure unit areas corresponding to the cell areas for recording either the information on 0 or the information on 1, and non-exposure areas consisting of non-exposure unit areas corresponding to the other cell areas for recording the other information; and
a development step of developing the resin layer to remove either exposed portions or unexposed portions of the resin layer selectively, thereby processing the resin layer into a concavo-convex pattern corresponding to the irregular servo exposure pattern.

16. The method of manufacturing a stamper according to claim 15, wherein
the irregular servo exposure pattern is one for not exposing near a border between at least two exposure unit areas adjoining in the radial direction out of the exposure unit areas, so that the adjoining exposure unit areas are exposed as divided in the radial direction.

17. A method of manufacturing a magnetic recording medium having a recording layer, the magnetic recording medium being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, the method comprising:
an exposure step of exposing portions of a resin layer of resist material of a workpiece, the portions corresponding to at least part of the servo areas, in an irregular servo exposure pattern for not exposing part of exposure areas of a basic servo exposure pattern so that at least some of the exposure areas of the basic servo exposure pattern are exposed as divided in a radial direction, the workpiece including a continuous recording layer yet over which the resin layer directly or indirectly formed thereon, the basic servo exposure pattern having the exposure areas consisting of exposure unit areas corresponding to the cell areas for recording either the information on 0 or the information on 1, and non-exposure areas consisting of non-exposure unit areas corresponding to the other cell areas for recording the other information; and
a development step of developing the resin layer to remove either exposed portions or unexposed portions of the resin layer selectively, thereby processing the resin layer into a concavo-convex pattern corresponding to the irregular servo exposure pattern.

18. The method of manufacturing a magnetic recording medium according to claim 17, wherein
the irregular servo exposure pattern is one for not exposing near a border between at least two exposure unit areas adjoining in the radial direction out of the exposure unit areas, so that the adjoining exposure unit areas are exposed as divided in the radial direction.

19. A method of manufacturing a magnetic recording medium having a recording layer, the magnetic recording medium being partitioned into a plurality of data areas and a plurality of servo areas, each of the servo areas being further partitioned into a plurality of cell areas, either an information on 0 or an information on 1 being recorded on each of the cell areas of the recording layer for use in a binary fashion according to a predetermined rule, the method comprising
an imprinting step of bringing a stamper into contact with a resin layer of a workpiece so that portions of the resin layer corresponding to at least part of the servo areas are formed into an irregular servo concavo-convex pattern,
at least some of either concave portions or convex portions of the irregular servo concavo-convex pattern being divided in a radial direction as compared with those of a basic servo concavo-convex pattern,
the workpiece including a continuous recording layer yet over which the resin layer directly or indirectly formed thereon, the basic servo concavo-convex pattern having concave portions consisting of concave unit areas corresponding to the cell areas for recording either the information on 0 or the information on 1, and convex portions consisting of convex unit areas corresponding to the other cell areas for recording the other information.

20. The method of manufacturing a magnetic recording medium according to claim 19, wherein
the irregular servo concavo-convex pattern is one in which a convex portion is formed near a border between at least two concave unit areas adjoining in the radial direction out of the concave unit areas to form concave portions divided in the radial direction in the adjoining concave unit areas.
